(19) United States
(12) Patent Application Publication
(10) Pub. No.: US 2014/0331768 A1
(43) Pub. Date: Nov. 13, 2014

(54) DETECTING CIRCUIT FOR FANS

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventors: BO TIAN, Shenzhen (CN); KANG WU, Shenzhen (CN)

(73) Assignees: HONG FU JIN PRECISION INDUSTRY (ShenZhen) CO., LTD., Shenzhen (CN); HON HAI PRECISION INDUSTRY CO., LTD., New Taipei (TW)

(21) Appl. No.: 14/273,549

(22) Filed: May 9, 2014

(30) Foreign Application Priority Data
May 9, 2013 (CN) 2013101685088

(51) Int. Cl. G01M 99/00; G01P 1/07

(52) U.S. Cl. CPC G01M 99/008; G01P 1/07
USPC 73/499; 73/488

(57) ABSTRACT

A detecting circuit for a number of fans includes a connector module and a controller. The connector module includes a number of connectors. Each connector outputs a first signal or a second signal depending on the connection or non-connection to a fan. The controller receives a speed signal of the fan upon receiving the first signal which indicates a connected state.

### FIELD

The present disclosure relates to a detecting circuit for fans.

### BACKGROUND

A number of fans are often employed to dissipate heat generated in a server. The fans can be coupled to connectors in the server, so as to be controlled by the baseboard management controller. A number of connectors may be predefined, so that additional fans can be employed to dissipate heat in the server.

### BRIEF DESCRIPTION OF THE DRAWINGS

Many aspects of the present disclosure can be better understood with reference to the following drawing(s). The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is a block diagram of an embodiment of a detecting circuit for fans of the present disclosure.

FIG. 2 is a circuit diagram of the detecting circuit of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

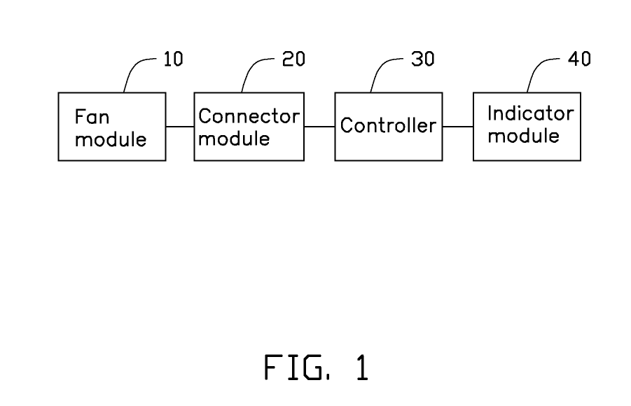

FIG. 1 illustrates an embodiment of a detecting circuit. The detecting circuit can comprise a fan module 10, a connector module 20, a controller 30, and an indicator module 40. In the embodiment, the connector module 30 can comprise a plurality of connectors, the fan module 10 can comprise a plurality of fans (not shown) to be respectively connected to the connectors. The fan module 10 can generate state information with respect to the plurality of fans. The controller 30 can be connected to the connector modules 20, to obtain the state information. The controller 30 can further output control signals to the indicator module 40, to indicate the status of the fans.

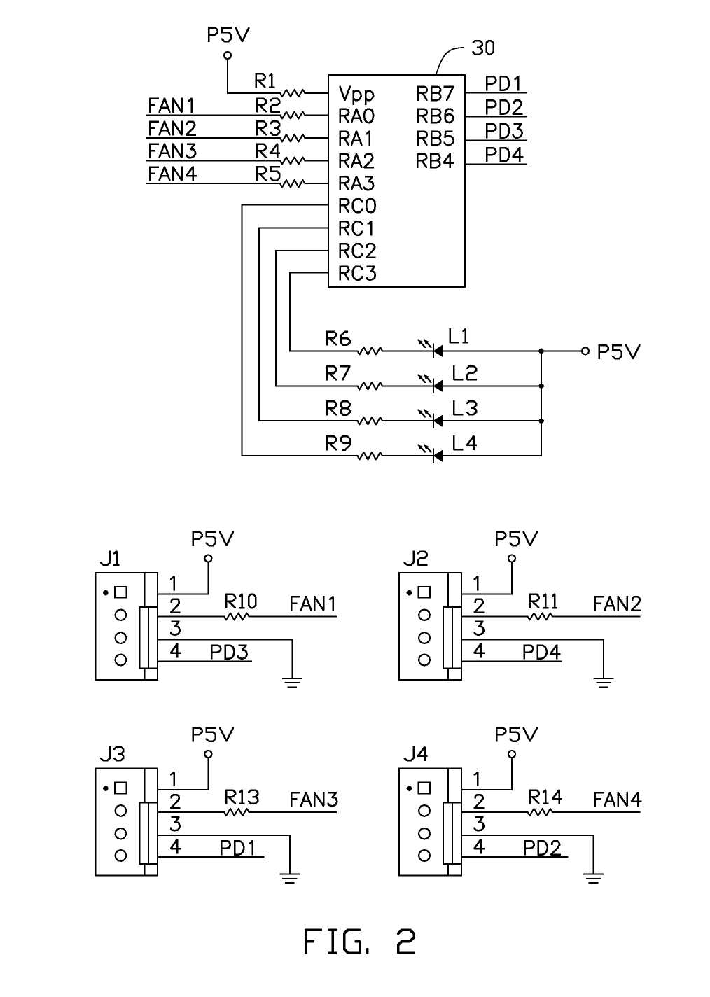

FIG. 2 illustrates a circuit diagram of the detecting circuit. In the embodiment, the connector module 20 can comprise connectors J1-J4. Each connector can comprise a power pin 1 coupled to a power terminal P5V, a speed pin 2, a ground pin 3 connected to ground, and a state pin 4. The speed pin 2 of the connector can output a speed signal upon a condition that a fan is connected to the connector. In the embodiment, the connectors J1 and J2 are connected to fans and the connectors J3 and J4 are not connected to fans. In other embodiment, the connectors J3 and J4 can be connected to additional fans that may be employed to satisfy the need of dissipating heat of a server.

The controller 30 can comprise four speed controlling pins RA0-RA3, four indicator pins RC0-RC3, four trigger pins RB4-RB7, and a power pin Vpp coupled to the power terminal P5V through a resistor R1. The speed controlling pins RA0-RA3 can be connected to the speed pins of a connector through two resistors connected in series. For example, the speed controlling pin RA0 is connected to the speed pin 2 of the connector J1 through resistors R2 and R10 connected in series. The speed controlling pin RA1 is connected to the speed pin 2 of the connector J2 through resistors R3 and R11 connected in series. The speed controlling pin RA2 is connected to the speed pin 2 of the connector J3 through resistors R4 and R13 connected in series. The speed controlling pin RA3 is connected to the speed pin 2 of the connector J4 through resistors R5 and R14 connected in series.

The indicator module 40 can comprise fourth light-emitting diodes (LEDs) L1-L4. In the embodiment, the LEDs L1-L4 can be employed to indicate the states of the fans that are connected to the connectors J1-14, such as normal status or a malfunctioning status. The indicator pins RC0-RC3 of the controller 30 are coupled to cathodes of the LEDs L1-L4 through respective resistors R6-R9. Anodes of the LEDs L1-L4 are coupled to the power terminal P5V. The trigger pins RB4-RB7 are respectively coupled to the state pins 4 of the connectors J4-J1.

In the embodiment, the state pin 4 of each connector can output logic-high signal, such as logic 1, upon the condition that the connector is connected to a fan, and output a logic-low signal, such as logic 0, upon a condition that the connector is not connected to a fan. For example, when the connector J3 is not connected to a fan, the state pin 4 of the connector J3 can output the logic-low level state signal to the trigger pin RB7 of the controller 30. Alternatively, when the connector J3 is connected to a fan, the state pin 4 of the connector J3 can output the logic-high level state signal to the trigger pin RB7 of the connector 30.

Accordingly, the controller 30 can determine whether the connector is connected to a fan or not, according to the voltage level at the trigger pins. In an embodiment, when the controller 30 obtains the speed of the fan, the controller 30 can determine whether the state pin 4 of the connector is at a logic-high or a logic-low level. If the state pin 4 of the connector is at logic-high level, the controller 30 then receives the speed signal from the speed pin 2 of the connector. If the state pin 4 of the connector is at logic-low level, the controller 30 then does not receive the speed signal from the speed pin 2 of the connector. Hence, the controller 30 can obtain the speed signal from the connector that has been connected to a fan. The controller 30 can further determine whether the fan is working normally or malfunctioning according to the speed signal. If the fan is malfunctioning, the controller 30 can further output logic-low level control signal to the anode of the corresponding LED to turn off the LED, to show that the fan is malfunctioning. In at least one embodiment, if the fan is operating normally, the controller 30 can further output logic-high level control signal to the anode of the corresponding LED, to turn on the relevant LED.

While the disclosure has been described by way of example and in terms of a preferred embodiment, it is to be understood that the disclosure is not limited thereto. On the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A detecting circuit, comprise:
a connector module comprising a plurality of connectors, wherein each of the connectors outputs a logic-low level state signal upon a condition that the connector is connected to a fan, each of the connectors outputs a logic-high level state signal upon condition that the connector is not connected to a fan; and
a controller, wherein the controller does not receive a speed signal from the connector upon receiving the low-voltage state signal of the connector, and receives the speed signal from the connector upon receiving the high-voltage state signal from the connector.

2. The detecting circuit of claim 1, further comprising:
an indicator module;
wherein the controller further determines whether the fan is normal according to the speed signal, when the fan functions abnormally, the controller outputs a control signal to the indicator module, to indicate fan malfunction.

3. The detecting circuit of claim 2, wherein the controller comprises a plurality of speed controlling pins, and each of the controlling pins of the controller is coupled to a speed pin of corresponding connector through a resistor.

4. The detecting circuit of claim 3, wherein the controller further comprises a plurality of trigger pins, and each of the trigger pins of the controller is coupled to a state pin of corresponding connector.

5. The detecting circuit of claim 3, wherein the controller further comprises a plurality of indicator pins, each of the indicator pins of the controller is coupled to a cathode of a light-emitting diode through a resistor, and anodes of the light-emitting diodes are coupled to a power terminal.
